(19) United States
(12) Patent Application Publication
(10) Pub. No.: US 2006/0288874 A1
(43) Pub. Date: Dec. 28, 2006

(54) In-Line, Instantaneous Carbonation System

(75) Inventor: Lawrence B. Ziesel, Woodstock, GA (US)

Correspondence Address: SUTHERLAND ASBILL & BRENNAN LLP, 999 PEACHTREE STREET, N.E., ATLANTA, GA, 30309, US

(73) Assignee: The Coca-Cola Compay, Atlanta, GA (US)

(21) Appl. No.: 11/160,464

(22) Filed: Jun. 24, 2005

(51) Int. Cl. A47J 31/00

(52) U.S. Cl. 99/279

(57) ABSTRACT

A beverage dispenser having a source of water and a source of gas. The beverage dispenser may include a beverage valve connected by one or more water lines to the source of water, a flow meter positioned about the water lines so as to determine a flow rate therethrough, and a proportioning device positioned about the source of gas so as to mix a predetermined volume of gas into the lines based upon the flow rate as determined by the flow meter.

### TECHNICAL FIELD

The present invention relates generally to beverage dispensers and more particularly relates to a beverage dispenser that injects carbon dioxide gas into a water stream.

### BACKGROUND OF THE INVENTION

Current beverage dispensers use plain water and/or carbonated water to mix with syrup, concentrate, or other types of additives so as to provide beverages. Plain water generally is supplied by a water supply system that may include a water source, a pump, and a bladder tank or other means of maintaining a constant water pressure. Carbonated water generally is supplied by a carbonation system. The carbonation system generally includes a gas source, a pump, and carbonator tank. The carbonator tank receives a flow of the plain water and a flow of the carbon dioxide so as to mix and produce the carbonated water. The carbonator tank also may include a level control so as to maintain a sufficient amount of carbonated water therein.

The carbonation system generally is a major component of the beverage dispenser as a whole. The carbonation system may have a significant weight and may occupy a significant percentage of the space of the beverage dispenser. The carbonator system also may tend to over-carbonate the water in winter, thus causing excessive foaming, and under-carbonate in the summer, thus causing poor drink quality.

What may be desired, therefore, is a beverage dispenser system that avoids the space, weight, and costs typically involved in a carbonation system. Preferably, the beverage dispenser system as a whole can provide high quality carbonated soft drinks and other beverages in a fast and efficient manner with a consistent carbonation level.

### SUMMARY OF THE INVENTION

The present application thus describes a beverage dispenser having a source of water and a source of gas. The beverage dispenser may include a beverage valve connected by one or more water lines to the source of water, a flow meter positioned about the water lines so as to determine a flow rate therethrough, and a proportioning device positioned about the source of gas so as to mix a predetermined volume of gas into the lines based upon the flow rate as determined by the flow meter.

The beverage dispenser further may include a water pump in communication with the source of water, an air bladder in communication with the water pump, and a cold plate in communication with the source of water. The water lines may include one or more water lines and one or more carbonated water lines.

The proportioning device may include a volumetric valve. The flow meter may include a paddle wheel. An electronic control board may be in communication with the proportioning device and the flow meter.

A method described herein may provide for producing a carbonated beverage from a source of water and a source of pressurized gas. The method may include chilling the water from the water source, flowing the water from the water source through a line, determining the flow rate of the water flowing through the line, and injecting a predetermined volume of the pressurized gas into the line based upon the determined flow rate.

The predetermined volume may be determined based upon a desired carbonation level for a given flow rate. A number of lines may be used and the method may include a number of predetermined volumes.

The present application further describes herein a beverage dispenser system. The beverage dispenser system may include a water supply system for providing a flow of water, a carbon dioxide injection system in communication with the water supply system for providing a flow of carbon dioxide, and a beverage valve in communication with the water supply system and the carbon dioxide injection system. The carbon dioxide injection system may include a flow meter and a proportioning device so as to provide a predetermined volume of carbon dioxide to the water supply system based upon the flow of the water as measured by the flow meter.

The proportioning device may include a volumetric valve. The flow meter may include a paddle wheel. An electronic control board may be in communication with the proportioning device and the flow meter.

The present application further describes herein an in-line mixing apparatus having a source of a first fluid and a source of a second fluid. The mixing apparatus may include a mixing area connected to the source of the first fluid by one or more lines. A flow meter may be positioned about the lines so as to determine a flow rate therethrough. A proportioning device may be positioned about the source of the second fluid so as to mix a predetermined volume of the second fluid into the lines based upon the flow rate of the first fluid as determined by the flow meter.

These and other features of the present invention will become apparent to one of ordinary skill in the art upon review of the following detailed description when taken in conjunction with the drawings and the appended claims.

### BRIEF DESCRIPTION OF THE DRAWING

FIG. 1 is a schematic view of the beverage dispenser as is described herein.

FIG. 2 is a schematic view of a volumetric valve that may be used herein.

### DETAILED DESCRIPTION

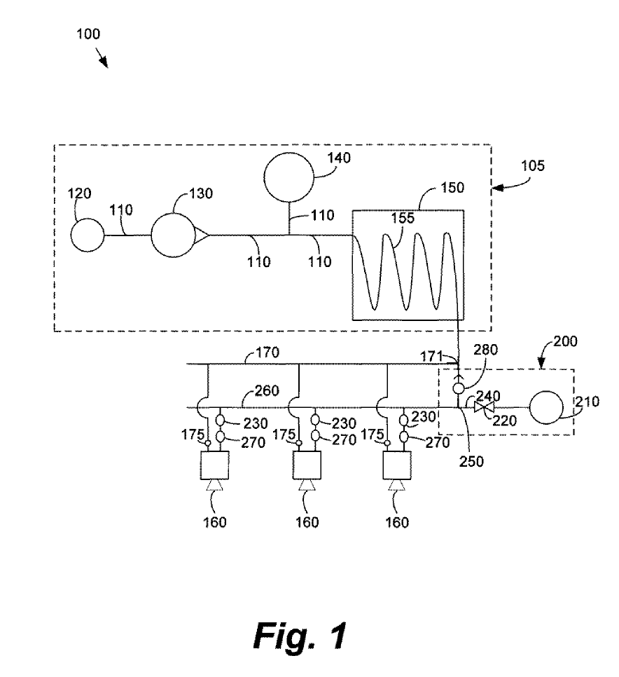

Referring now to the drawings, in which like numerals refer to like elements throughout the several views, FIG. 1 shows a schematic view of a beverage dispenser system 100 as is described herein. The components of the dispenser system 100 as described below may be positioned within a common housing and/or the components may be separately housed.

The beverage dispenser system 100 may include a number of internal fluid lines or conduits 110 so as to connect the various components as described below. The size and/or diameter of the lines 110 may depend upon the size and volume of the overall beverage dispenser system 100. In general, the lines 110 may be about 0.25 inches (about 6.35 millimeters) or larger in inside diameter. The lines 110 that do not come into contact with the carbon dioxide or the carbonated water may be made out of copper, stainless steel, plastic, or other types of substantially non-corrosive materials. Those lines 110 that do come into contact with the carbon dioxide or the carbonated water generally are made out of stainless steel or other types of substantially non-corrosive and non-reactive materials.

The beverage dispenser system 100 may include a water supply system 105. The water supply system 105 may include a source 120 of plain water. The source 120 of plain water may provide tap water, packaged water, or any other source of plain water as may be available.

The water supply system 105 of the beverage dispenser system 100 also may include a water pump 130. The water pump 130 may be a conventional positive displacement pump or a similar type of device. Any type of water moving device may be used. The pump 130 may have a capacity of about 100 to about 300 gallons per hour (about 378.5 to about 1,135 liters per hour). Other capacities may be used depending upon the overall size and volume of the beverage dispenser system 100 as a whole. The pump 130 may be connected to the source 120 of water via one of the lines 110.

The water supply system 105 of the beverage dispenser system 100 also may include an air bladder tank 140. The air bladder tank 140 may be of conventional design. The air bladder tank 140 may include a volume of water therein so as to supply a constant and consistent water flow pressure. Any other device for maintaining a constant water pressure may be used. The bladder tank 140 may provide water at about 80 to about 100 psig (about 5.62 ksc to about 7 ksc). The air bladder tank 140 may be connected to the water pump 130 via one or more lines 110. The air bladder tank 140 also may be separately connected to the source 120 of water via one or more lines 110 or to any other water source.

The water supply system 105 of the beverage dispenser 100 may include a cold plate 150. The cold plate 150 may be associated with a cooling source such as a refrigeration system, an ice water tank, or any other source of cooling. The cold plate 150 may include a number of internal passages 155 for heat transfer with the cooling source. Any other type of heat transfer means may be used. Although one (1) cold plate 150 is shown, any desired number may be used. The cold plate 150 may be in communication with the source 120 of water, the water pump 130, and the air bladder tank 140 via one or more lines 110.

The cold plate 150 may chill the water to close to about forty degrees (40°) Fahrenheit (about 4.4° Celsius). Other temperatures may be used herein. Preferably, the water will reach about the desired temperature in one (1) pass through the cold plate 150 as opposed to the multiple passes generally used in known devices. An additional pass though the cold plate 150 also may be desired once the carbon dioxide gas has been added to the water stream so as to promote dissolving the gas within the water.

The beverage dispenser system 100 may include a number of beverage valves 160. The beverage valves 160 may include conventional dispensing valves in which plain water, carbonated water, syrup, concentrate, bonus flavors, and/or other types of fluid flows are mixed so as to create and dispense a beverage. The beverage valves 160 may be of conventional design. In this example, three (3) beverage valves 160 are used. Any number of beverage valves 160 or other types of devices, however, may be used herein.

The beverage valves 160 may be connected to the water supply system 105 by one or more lines 110. In this case, one or more plain water lines 170 may be used. Specifically, each beverage valve 160 may be supplied by a plain water line 170. A conventional T-joint 171 or a similar device may be used to branch the plain water lines 170 from the line 110 exiting the cold plate 150. Any number of plain water lines 170 may be used. Multiple plain water lines 150 may be used or a single water line 170 may branch out into multiple lines as is shown.

Each plain water line 170 may have a plain water solenoid valve 175 positioned thereon so as to turn on and off the flow of carbonated water to each beverage valve 160. The solenoid valve 175 may be any type of on and off device.

The beverage dispenser system 100 also may include a carbon dioxide injection system 200. The carbon dioxide injection system 200 may include a source 210 of pressurized carbon dioxide. The source 210 of pressurized carbon dioxide may be any type of conventional pressurized source. The source 210 may provide carbon dioxide at about 120 psig (about 8.4 ksc) and/or at least about 20 psig (about 1.4 ksc) greater than the water pressure. Other pressures may be used depending upon the size and volume of the beverage dispenser system 100 as a whole.

The carbon dioxide injection system 200 may include a proportioning device 220 and one or more flow meters 230. The proportioning device 220 may be a volumetric valve or a similar type of device that measures a water flow rate based upon input from the flow meter 230 and injects a predetermined volume of carbon dioxide into the water stream. The proportioning device 220 may be a volumetric valve similar to that disclosed in commonly owned U.S. Pat. Nos. 5,381,926 and 6,435,375, incorporated herein by reference, or a similar type of device. The proportioning device 220 may be in communication with a conventional electronic control board 225. The electronic control board 225 may include a microprocessor or a similar type of control device. The proportioning device 220 may be in communication with the source 210 of carbon dioxide via one or more lines 110.

The flow meter 230 may be a conventional paddle wheel or similar type of measuring or counting device. Any type of metering device may be used. The flow meter 230 provides the proportioning device 220 with the water flow rate via a number of counts or pulses or via similar methods.

The proportioning device 220 of the carbon dioxide injection system 200 may be in communication with the water supply system 105 and the beverage valves 160 via one or more lines 110. In this case, one or more gas lines 240 may be in communication with the source 210 of carbon dioxide. In turn, the gas line or lines 240 may merge with the plain water line 170 via a conventional T-joint 250 or a similar type of device. From the T-joint 250, the merged plain water and carbon dioxide streams may be in communication with the beverage valves 160 via one or more lines 110. In this case, one or more carbonated water lines 260 may be used. Any number of carbonated water lines 260 may be used. Multiple carbonated water lines 260 may be used or a single water line 260 may branch out into multiple lines as is shown.

One of the flow meters 230 may be positioned on each of the carbonated water lines 260 just up stream of each beverage valve 160. The carbonated water lines 260 each may have a carbonated water solenoid valve 270 positioned thereon so as to turn on and off the flow of carbonated water to each beverage valve 160. The solenoid valve 270 may be any type of on and off device.

Positioned upstream of the T-joint 190 and the carbonated water line 260 may be a check valve 280. The check valve 280 may be of conventional design. The check valve 280 may prevent the backflow of carbonated water through the carbonated water line 260, if needed.

In use, plain water is provided to each of the beverage valves 160 via the water system 105. Likewise, carbonated water is provided to each of the beverage valves 160 via the water supply system 105 in combination with the carbon dioxide injection system 200. Based upon the amount of water that is monitored by the flow meter 230, the proportioning device 220 injects the predetermined volume of pressurized carbon dioxide gas into the carbonated water line 260.

The proportioning device 220 can inject any predetermined volume of carbon dioxide gas based upon the determined flow rate. For example, five (5) volumes of carbon dioxide may be provided for a given volume of water for a carbonated beverage. The proportioning device 220 may be programmed via the electronic control board 225 such that the given volume of carbon dioxide gas is provided for a given number of counts or pulses as measured by the flow meter 230. The given volume may be based upon a look up table or similar types of control logic. The proportioning device 220 may be set for flows of, for example, about one (1) to about five (5) ounces per second (about 29.6 to about 148 milliliters per second) as may be desired. Likewise, the proportioning device 220 may be programmed such that one or more of the beverage valves 160 may be operating at the same time.

The carbon dioxide injection system 200 also may provide variable carbonation levels. The beverage dispenser system 100 thus may be able to provide carbonated and noncarbonated beverages as well as beverages with variable or intermediate carbonation levels on demand. The electronic control board 225 may have a number of preset carbonation levels corresponding to the nature of the beverages to be served from the beverage dispenser system 100. The proportioning device 220 may provide the correct volume of carbon dioxide as instructed by the electronic control board 225 for a selected beverage.

The beverage dispenser system 100 thus eliminates the conventional carbonator tank as well as the associated motor, pump, and level control. Further, a pump and a motor also may be eliminated in those systems that use a separate circuit for plain and carbonated water. As a result, the beverage dispenser system 100 therefore has a reduced weight and overall footprint. Likewise, improved and consistent carbonation levels are provided for the dispensed beverages given the use of the preset carbonation levels.

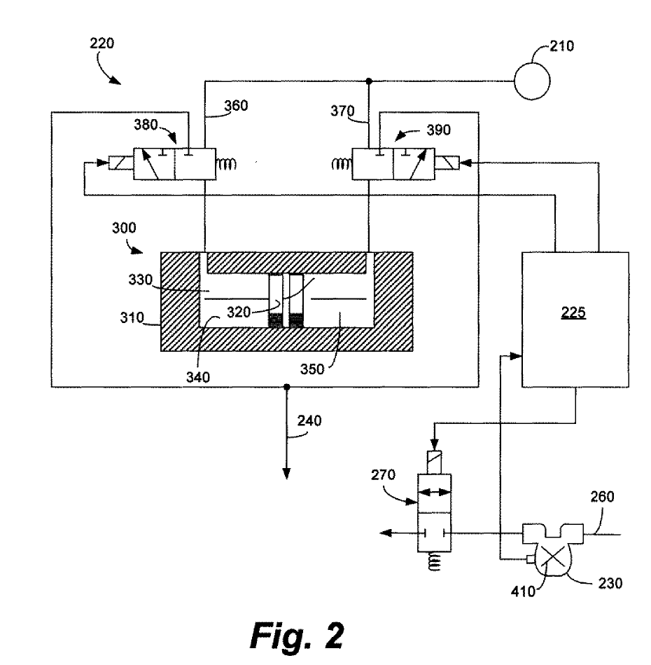

As is shown in FIG. 2, the proportioning device 220 may take the form of a volumetric dispensing valve 300. The volumetric dispensing valve 300 may include a cylindrical sleeve 310 and a reciprocating piston 320 disposed therein. The piston 320 divides a pump chamber 330 defined by the sleeve 310 into separate portions 340, 350. Communicating with the pump chamber 330 are a pair of fluid inlet passages 360, 370. These passages 360, 370 are in communication with the source 210 of carbon dioxide. The solenoid valves 380, 390 may be positioned in communication with the passages 360, 370. Each of the solenoid valves 380, 390 are actuable between first and second positions in response to control signals received from an electronic control board 400. Each valve 380, 390 has a first position that permits gas flow therethrough into the pump chamber 330. Each valve 380, 390 likewise has a second position that permits gas flow therethrough from the chamber 330 and out of the dispensing pump 300.

The flow meter 230 may have a rotatable paddle wheel 410. The flow meter 230 determines the flow rate therethrough and communicates with the electronic control board 225. The electronic control board 225 also may be in communication with the solenoid valve 270.

The schematic of FIG. 2 shows the proportioning device 220 in its deactivated state wherein the solenoid valves 380, 390 are both in the de-energized position. To begin a dispensing operation, the solenoid valve 270 is activated to an energized or open position. At this time, the valves 380, 390 are in opposite states, one de-energized and one energized. Carbonated water will then begin to flow through the flow meter 230 and cause the paddle wheel 410 to rotate. Rotation of the paddle wheel 410 is measured and appropriate pulse signals are sent to the electronic control board 225. The electronic control board 225 then energized and de-energizes the solenoid valves 380, 390 so as to pump a predetermined volume of the pressurized carbon dioxide gas. Similar types of proportioning devices may be used herein.

It should be understood that the foregoing relates only to the preferred embodiments of the present invention and that numerous changes and modifications may be made herein without departing from the general spirit and scope of the invention as defined by the following claims and the equivalents thereof.

What is claimed is:

1. A beverage dispenser having a source of water and a source of gas, comprising:
a beverage valve;
said beverage valve and the source of water connected by one or more water lines;
a flow meter positioned about said one or more water lines so as to determine a flow rate therethrough; and
a proportioning device positioned about the source of gas so as to mix a predetermined volume of gas into said one or more lines based upon said flow rate as determined by the flow meter.

2. The beverage dispenser of claim 1, further comprising a water pump in communication with the source of water.

3. The beverage dispenser of claim 2, further comprising an air bladder in communication with said water pump.

4. The beverage dispenser of claim 1, further comprising a cold plate in communication with the source of water.

5. The beverage dispenser of claim 1, wherein said one or more water lines comprise one or more water lines and one or more carbonated water lines.

6. The beverage dispenser of claim 1, wherein said proportioning device comprises a volumetric valve.

7. The beverage dispenser of claim 1, wherein said flow meter comprises a paddle wheel.

8. The beverage dispenser of claim 1, further comprising an electronic control board in communication with said proportioning device and said flow meter.

9. A method of producing a carbonated beverage from a source of water and a source of pressurized gas, comprising:
chilling the water from the water source;
flowing the water from the water source through a line;
determining the flow rate of the water flowing through the line; and
injecting a predetermined volume of the pressurized gas into the line based upon the determined flow rate.

10. The method of claim 9, wherein the predetermined volume is determined based upon a desired carbonation level for a given flow rate.

11. The method of claim 9, further comprising a plurality of lines and wherein said method comprises a plurality of predetermined volumes.

12. A beverage dispenser system, comprising:
a water supply system for providing a flow of water;
a carbon dioxide injection system in communication with said water supply system for providing a flow of carbon dioxide; and
a beverage valve in communication with said water supply system and said carbon dioxide injection system;
said carbon dioxide injection system comprising a flow meter and a proportioning device so as to provide a predetermined volume of carbon dioxide to said water supply system based upon the flow of water as measured by the flow meter.

13. The beverage dispenser system of claim 12, wherein said proportioning device comprises a volumetric valve.

14. The beverage dispenser system of claim 12, wherein said flow meter comprises a paddle wheel.

15. The beverage dispenser system of claim 12, further comprising an electronic control board in communication with said proportioning device and said flow meter.

16. An in-line mixing apparatus having a source of a first fluid and a source of a second fluid, comprising:
a mixing area;
said mixing area and the source of the first fluid connected by one or more lines;
a flow meter positioned about said one or more lines so as to determine a flow rate therethrough; and
a proportioning device positioned about the source of the second fluid so as to mix a predetermined volume of the second fluid into said one or more lines based upon the flow rate of the first fluid as determined by the flow meter.
